(19) United States
(12) Patent Application Publication
(10) Pub. No.: US 2014/0317549 A1
(43) Pub. Date: Oct. 23, 2014

(54) Method for Controlling Touchscreen by Using Virtual Trackball

(71) Applicant: The Klever Co., Ltd., Gyeongsangbuk-do (KR)

(72) Inventors: Doo Geon Hwang, Busan (KR); Chul Soo Kim, Gyeongsangnam-do (KR)

(73) Assignee: The Klever Co., Ltd., Gyeongsangbuk-do (KR)

(21) Appl. No.: 14/249,134

(22) Filed: Apr. 9, 2014

(30) Foreign Application Priority Data
Apr. 17, 2013 (KR) 10-2013-0042446

(51) Int. Cl. G06F 3/0488; G06F 3/0484; G06F 3/0481

(52) U.S. Cl. CPC G06F 3/04886; G06F 3/04812; G06F 3/04842
USPC 715/773

(57) ABSTRACT

Disclosed herein is a method for controlling a touchscreen by using a virtual trackball. The method for controlling the touchscreen includes the steps of displaying a virtual keyboard on the input window, displaying a virtual trackball by selecting an Execute button on the virtual keyboard, enlarging a cursor displayed on the output window and a predetermined region surrounding the cursor, and inputting movement information of the cursor being enlarged and displayed by using the virtual trackball.

This application claims the benefit of the Korean Patent Application No. 10-2013-0042446, filed on Apr. 17, 2013, which is hereby incorporated by reference as if fully set forth herein.

### BACKGROUND OF THE INVENTION

1. Field of the Invention

The present invention relates to a virtual trackball and, more particularly, to a method for controlling a touchscreen by using a virtual trackball enabling space shift and line change operations to be performed more accurately when inputting text on a touchscreen.

2. Discussion of the Related Art

A mobile (or portable) user equipment (or user terminal) corresponds to a device that can be handheld or worn by a user. Herein, the mobile device is provided with one or more functions, such as a voice or video phone function, a data communication function, information input and output function, and data storage function.

Additionally, as the functions of mobile user equipments are becoming more diverse, the mobile user equipment is also provided with application execution functions, such as taking pictures or recording moving picture images through a camera, which is equipped to the mobile user equipment, playing music or moving picture images, playing games, receiving broadcasting, and so on. And, the mobile user equipment is also being realized in the form of a comprehensive and general multimedia device.

A touchscreen is being used as an inputting and outputting means for the mobile user equipment, and an output of a display screen is controlled and displayed based upon a touch input of the user.

Accordingly, among the related art methods for controlling a touchscreen, a “handheld electronic and associated method providing advanced text editing function in a text disambiguation environment” is disclosed in the Korean Patent Application No. 10-1000840. Having a trackball equipped to the mobile user equipment, the handheld electronic and associated method providing advanced text editing function in a text disambiguation environment provides a more enhanced (or improved) text editing function in a text environment performing the same function as a joystick.

Recently, since there is an inconvenience of not being capable of using the trackball function in mobile user equipments that are not equipped with the trackball device, a technology for realizing a virtual trackball has been developed.

However, when using the related art virtual trackball technology, due to the small size of the text and cursor being displayed on the output window of the display screen, it is difficult to accurately perform space shift and line change operations. And, most particularly, users having poor eyesight tend to experience inconvenience and discomfort due to such small features.

Additionally, the related art method is also disadvantageous in that the size of the virtual trackball and cursor being displayed on the output window of the display screen and the size of the surrounding region of the cursor cannot be adjusted.

### SUMMARY OF THE INVENTION

Accordingly, the present invention is directed to a method for controlling a touchscreen by using a virtual trackball that substantially obviates one or more problems due to limitations and disadvantages of the related art.

An object of the present invention is to provide a method for controlling a touchscreen by using a virtual trackball that can enable users having poor eyesight to select an Enlarged Mode when executing a virtual trackball, so that sizes of a cursor and a predetermined region surrounding the cursor can be enlarged and displayed, and so that a size of a virtual trackball can also be enlarged and displayed.

Another object of the present invention is to provide a method for controlling a touchscreen by using a virtual trackball that can enable the user to arbitrarily adjust display sizes of the cursor, which is displayed on the output window of the touchscreen, the surrounding region of the cursor, and the virtual trackball.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in an aspect of the present invention, as a method for controlling a touchscreen displaying text and a cursor on an output window, after differentiating an input window from an output window within the touchscreen, the method for controlling the touchscreen includes the steps of displaying a virtual keyboard on the input window, displaying a virtual trackball by selecting an Execute button on the virtual keyboard, enlarging a cursor displayed on the output window and a predetermined region surrounding the cursor, and inputting movement information of the cursor being enlarged and displayed by using the virtual trackball.

The step of enlarging a cursor displayed on the output window and a predetermined region surrounding the cursor may further include the step of enlarging and displaying a virtual trackball of the input window, and a user may be capable of arbitrarily setting up a size of the virtual trackball being enlarged and displayed or sizes of the cursor and the surrounding region of the cursor both being enlarged and displayed.

Herein, the method further includes the step of having the user select an Enlarged Mode configured to enlarge and display a predetermined region of the output window, and, in the step of enlarging a cursor displayed on the output window and a predetermined region surrounding the cursor, the Enlarged Mode may be executed, in case the Execute button displayed on the virtual keyboard is selected for more than a predetermined period of time, or in case the Execute button is selected for more than a predetermined number of times, or in case a separate Select button is selected, when the Execute button has been selected.

The virtual trackball may be displayed on the input window in a region surrounding the Execute button, and the movement information includes movement direction information indicating a direction along which the cursor is being moved, and button information of the virtual trackball being used, when the cursor is moved, and the movement direction information may include up, down, left, and right directions.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block view of a user equipment configured for realizing a method for controlling a touchscreen by using a virtual trackball according to an exemplary embodiment of the present invention;

FIG. 2 illustrates a flow chart showing a method for controlling a touchscreen by using a virtual trackball according to an exemplary embodiment of the present invention;

FIG. 3 illustrates a phase diagram showing the method for controlling a touchscreen by using a virtual trackball according to the exemplary embodiment of the present invention being realized on a touchscreen;

FIG. 4 illustrates a phase diagram showing an exemplary realization of a method for controlling a cursor by using a virtual trackball in the method for controlling a touchscreen by using a virtual trackball according to the exemplary embodiment of the present invention; and

FIG. 5 illustrates an exemplary set-up screen of the method for controlling a touchscreen by using a virtual trackball according to the exemplary embodiment of the present invention.

### DETAILED DESCRIPTION OF THE INVENTION

The present invention provides a method for controlling a touchscreen by using a virtual trackball. Reference will now be made in detail to the preferred embodiments of the present invention, examples of which are illustrated in the accompanying drawings. Wherever possible, the same reference numbers will be used throughout the drawings to refer to the same or like parts.

The exemplary embodiments of the present invention will be sufficiently described in detail so that the present invention can be realized by anyone skilled in the art. It will be apparent that other exemplary embodiments may be used herein, and that various modifications and variations can be made in the present invention without departing from the spirit or scope of the inventions. Thus, the detailed description of the present invention will not limited the scope and spirit of the present invention and shall be defined by and within the scope of the appended claims and their equivalents.

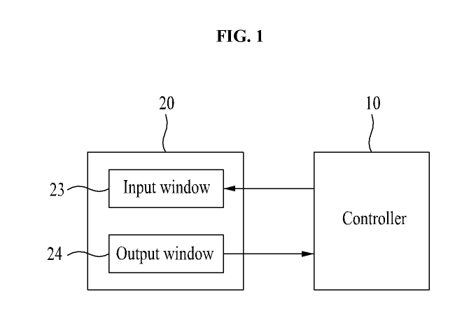

FIG. 1 illustrates a block view of a user equipment configured for realizing a method for controlling a touchscreen by using a virtual trackball according to an exemplary embodiment of the present invention.

As shown in FIG. 1, a virtual keyboard is displayed on a touchscreen 20, and an input window 23 configured to input text via touch input on the virtual keyboard, an output window 24 configured to output and display the inputted text, and a controller 10 configured to perform control operations for recognizing the touch input of the text on the virtual keyboard and for outputting and displaying the inputted text, are provided.

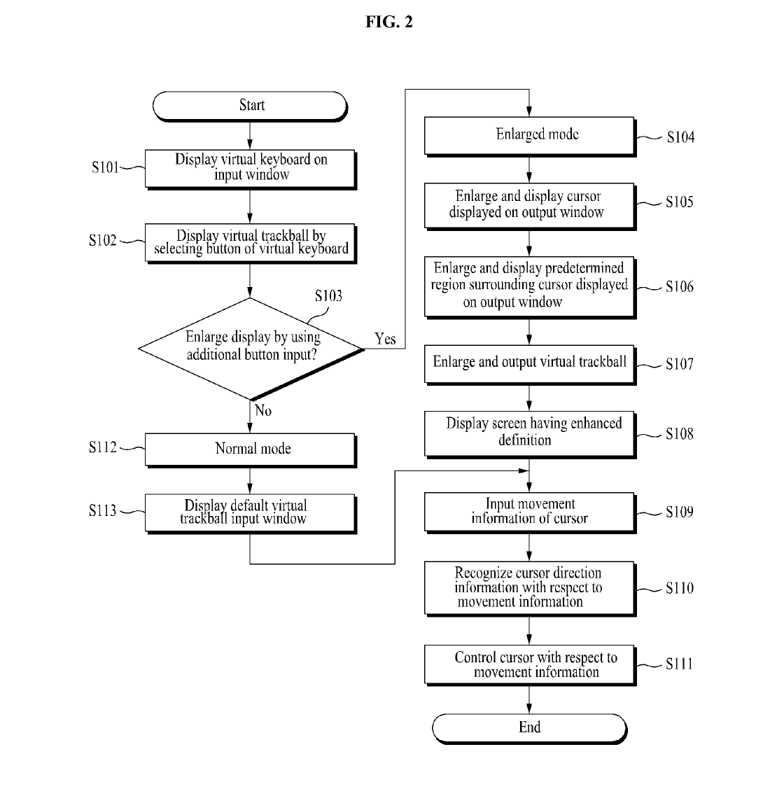

FIG. 2 illustrates a flow chart showing a method for controlling a touchscreen by using a virtual trackball according to an exemplary embodiment of the present invention. As shown in FIG. 2, the method for controlling the touchscreen according to the present invention first identifies the input window 23 and the output window 24 on the touchscreen 20 of the mobile user equipment and, then, displays a text and a cursor on the output window 24.

Then, a virtual keyboard is displayed on the input window 23 within the touchscreen 20 (S101).

The touchscreen 20 consists of a general monitor screen having a device, which is referred to as a touch panel, attached thereto, thereby being capable of performing an input function. By having invisible infrared light rays flow in left-and-right (or horizontal) directions and up-and-down (or vertical) directions, so that a multitude of rectangular (or square) grids can be formed, the touch panel may perform a function of determining a touched position within the multitude of rectangular grids, when the rectangular grids are touched with a tip of the user's finger or another object.

Thereafter, by selecting an Execute button of the virtual keyboard, a virtual trackball is displayed (S102).

The Execute button of the virtual keyboard corresponds to an arbitrary button within the virtual keyboard, which executes the virtual keyboard. Herein, any one of the buttons displayed on the virtual keyboard may be designated as the Execute button, and the Execute button will not be limited only to any one of the buttons shown in FIG. 2.

The virtual keyboard is displayed on the touchscreen 20, and the virtual keyboard may be used to input text through a QWERTY keyboard, a CHEON-JI-IN scheme, and so on. However, the present invention will not be limited only to any one of the schemes presented in the exemplary embodiment of the present invention.

Within the virtual trackball, a separate Select button is displayed (S103), when any one button is additionally selected for a predetermined period of time, or when any one button is selected for more than a predetermined number of times, or when the Execute button is selected, and an Enlarged Mode of an enlarged display step is executed by selecting an Enlarged Display button (S104).

Herein, a method for selecting a separate button, when the separate Select button is displayed (S103), when any one button is additionally selected for a predetermined period of time, or when any one button is selected for more than a predetermined number of times, or when the Execute button is selected, may correspond to a method for executing the enlarged display of the virtual trackball, and the corresponding method may include a variety of similar methods.

When the Enlarged Mode is executed, a cursor displayed on the output window 24 is enlarged and displayed (S105), and the surrounding region of the cursor is also enlarged and displayed (S106).

Additionally, the virtual trackball is also enlarged and displayed (S107), and the definition (or resolution) of the text and virtual keyboard, which are displayed on the touchscreen 20, become more enhanced (S108).

Thereafter, movement information of the cursor, which is enlarged and displayed, is inputted by using the virtual keyboard (S109).

The cursor recognizes direction information in accordance with the movement information (S110), and the cursor is maneuvered and controlled in accordance with the direction information (S111).

When the virtual trackball is displayed, and when the separate Select button is displayed (S103), when any one button is additionally selected for a predetermined period of time, or when any one button is selected for more than a predetermined number of times, or when the Execute button is selected, if a Normal Mode button is selected instead of the Enlarged Mode button, the display mode will be referred to as a Normal Mode.

The Execute button corresponds to a button that can execute the virtual trackball.

The Enlarged Mode of the virtual trackball may be executed by using the Execute button. And, herein, a button other than the button for executing the virtual trackball may be designated as the Execute button.

When the Normal Mode is executed (S112), a default virtual trackball, which is determined by default settings in the virtual trackball, is displayed on the input window 23 (S113).

The output window 24 corresponding to the case when the Normal Mode is executed is outputted identically as the output window 24 prior to the execution of the Normal Mode. And, in this case, the size of the cursor respective to the Normal Mode is also the same as the size of the cursor prior to the execution of the Normal Mode.

Thereafter, movement information of the cursor, which is enlarged and displayed, is inputted by using the virtual keyboard (S109). Subsequently, the cursor recognizes direction information in accordance with the movement information (S110), and, then, the cursor is maneuvered and controlled in accordance with the direction information (S111).

The movement information includes movement direction information indicating a direction along which the cursor is moving and button information of the virtual trackball, which is used when the cursor is moved. Herein, the movement direction information includes the directions of up, down, left, and right.

The adjustment of the level of enlargement and the level of definition (or resolution) of the virtual trackball, the cursor, and the predetermined region surrounding the cursor may be set up at any time, such as during the execution of the virtual trackball, before the execution of the virtual trackball, or after the execution of the trackball. And, the level of enlargement or the level of definition may be adjusted by controlling and changing number points or a control bar within the set-up screen. Alternatively, a button displaying a pre-decided level of enlargement and level of definition may be displayed.

Additionally, although the level of enlargement and level of definition of the virtual trackball, the cursor, and the predetermined region surrounding the cursor may be individually adjusted and controlled, by performing a single adjustment operation for the level of enlargement and level of definition, a collective adjustment of the level of enlargement and level of definition may be performed in proportion to the single adjustment operation.

The text includes characters (or letters), numbers, and signs. Additionally, the virtual trackball is displayed on the input window 23.

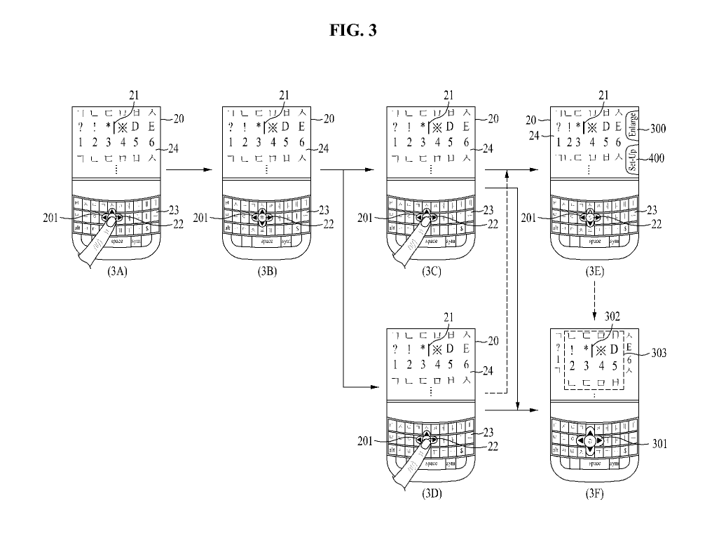

FIG. 3 illustrates a phase diagram showing the method for controlling a touchscreen by using a virtual trackball according to the exemplary embodiment of the present invention being realized on a touchscreen. As shown in FIG. 3A, in a state when the text and the cursor 21 are displayed on the output window 24 of the touchscreen 20, the Execute button 22 within the virtual keyboard of the input window 23 is selected, and the virtual trackball is displayed.

Additionally, when the virtual trackball is displayed, as shown in FIG. 3B, the virtual trackball is displayed on the input window 23 in the Normal Mode.

Additionally, the Enlarged Mode may be displayed on the display screen.

As shown in FIG. 3C, when any one button 22, which is displayed on the virtual keyboard, is selected for more than a predetermined period of time, as shown in FIG. 3F, the Enlarged Mode is executed, wherein the virtual trackball 301, the cursor 302, and a predetermined region 303 surrounding the cursor are enlarged and displayed.

As shown in FIG. 3D, when any one button 22, which is displayed on the virtual keyboard, is selected for more than a predetermined number of times, as shown in FIG. 3F, the Enlarged Mode is executed, wherein the virtual trackball 301, the cursor 302, and a predetermined region 303 surrounding the cursor are enlarged and displayed.

As shown in FIG. 3C, when an Execute button 22, which is displayed on the virtual keyboard, is selected for more than a predetermined period of time, as shown in FIG. 3E, an Enlarged Mode button 300 configured to enable the Enlarged Mode to be selected and a Set-Up Mode button 400 configured to enable the size of display in the Enlarged Mode to be adjusted are displayed.

Then, when the Enlarged Mode button 300 is selected, as shown in FIG. 3F, the virtual trackball 301, the cursor 302, and a predetermined region 303 surrounding the cursor are enlarged and displayed.

As shown in FIG. 3D, when an Execute button 22, which is displayed on the virtual keyboard, is selected for more than a predetermined number of times, as shown in FIG. 3E, an Enlarged Mode button 300 configured to enable the Enlarged Mode to be selected and a Set-Up Mode button 400 configured to enable the size of display in the Enlarged Mode to be adjusted are displayed. And, then, when the Enlarged Mode button 300 is selected, as shown in FIG. 3F, the virtual trackball 301, the cursor 302, and a predetermined region 303 surrounding the cursor are enlarged and displayed.

The Execute button 22 corresponds to a button that can execute the virtual trackball.

The Enlarged Mode of the virtual trackball may be executed by using the Execute button 22. And, herein, a button other than the button for executing the virtual trackball may be designated as the Execute button 22.

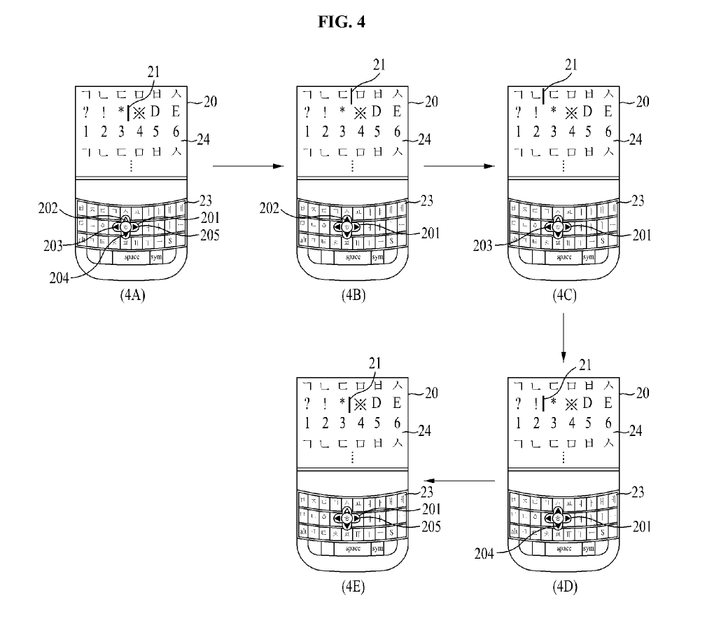

FIG. 4 illustrates a phase diagram showing an exemplary realization of a method for controlling a cursor by using a virtual trackball in the method for controlling a touchscreen by using a virtual trackball according to the exemplary embodiment of the present invention. As shown in FIG. 4A, when it is assumed that the user executes a virtual trackball and that the user inputs text in an output window 24 of the touchscreen 20, the virtual trackball 201 and the cursor 21 are displayed.

In this situation, when the user selects an Up direction button 202 of the virtual trackball 201, as shown in FIG. 4B, the cursor 21 may change a line along an upward direction.

Moreover, at this point, when the user selects a Left direction button 203 of the virtual trackball 201, as shown in FIG. 4C, the cursor 21 may shift a space along a leftward direction.

Also, at this point, when the user selects a Down direction button 204 of the virtual trackball 201, as shown in FIG. 4D, the cursor 21 may change a line along a downward direction.

Furthermore, at this point, when the user selects a Right direction button 205 of the virtual trackball 201, as shown in FIG. 4E, the cursor 21 may shift a space along a rightward direction.

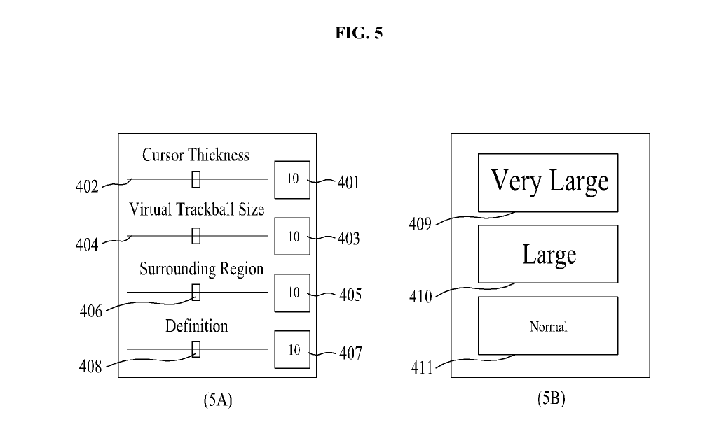

FIG. 5 illustrates an exemplary set-up screen of the method for controlling a touchscreen by using a virtual trackball according to the exemplary embodiment of the present invention. When the Set-Up button 400 of FIG. 3E is selected, the screen is displayed as shown in FIG. 5A or FIG. 5B.

As shown in FIG. 5A, a level of enlargement of the cursor may be adjusted 401 by points, and the adjustment may be performed by moving a control bar 402 along a horizontal (or left-to-right) direction.

Additionally, a size of the virtual trackball may also be adjusted 403 by points, and the adjustment may be performed by moving a control bar 404 along a horizontal (or left-to-right) direction.

Moreover, a level of enlargement of the predetermined region surrounding the cursor may also be adjusted 405 by points, and the adjustment may be performed by moving a control bar 406 along a horizontal (or left-to-right) direction.

Furthermore, a level of resolution (or definition) respective to the display screen of the touchscreen 20 may also be adjusted 407 by points, and the adjustment may be performed by moving a control bar 408 along a horizontal (or left-to-right) direction.

As shown in FIG. 5B, by using a Very Large button 409, a Large button 410, and a Normal button 411, the level of enlargement of the cursor and the predetermined region surrounding the cursor, the size of the virtual trackball, and the level of resolution (or definition) respective to the display screen may be adjusted by a single touch input. Herein, with respect to the Normal button 409, the level of enlargement of the cursor and the predetermined region surrounding the cursor, the size of the virtual trackball, and the level of resolution (or definition) respective to the display screen may be set up to be displayed larger and more vividly to a predetermined level as compared to the level of enlargement of the cursor and the predetermined region surrounding the cursor, the size of the virtual trackball, and the level of resolution (or definition) respective to the display screen, which are displayed at least in the Normal Mode.

Additionally, with respect to the Large button 410, the level of enlargement of the cursor and the predetermined region surrounding the cursor, the size of the virtual trackball, and the level of resolution (or definition) respective to the display screen may be set up to be displayed larger and more vividly to a predetermined level as compared to the level of enlargement of the cursor and the predetermined region surrounding the cursor, the size of the virtual trackball, and the level of resolution (or definition) respective to the display screen, wherein the Normal button 409 is applied.

Furthermore, with respect to the Very Large button 411, the level of enlargement of the cursor and the predetermined region surrounding the cursor, the size of the virtual trackball, and the level of resolution (or definition) respective to the display screen may be set up to be displayed larger and more vividly to a predetermined level as compared to the level of enlargement of the cursor and the predetermined region surrounding the cursor, the size of the virtual trackball, and the level of resolution (or definition) respective to the display screen, wherein the Large button 410 is applied.

Moreover, according to another exemplary embodiment of the present invention, any one of the Normal Mode and the Enlarged Mode may be set up in advance with respect to the virtual trackball.

When the virtual trackball is set in advance to the Normal Mode, and when the virtual trackball is executed, the virtual trackball may be executed and operated in the Normal Mode. And, when the virtual trackball is set in advance to the Enlarged Mode, and when the virtual trackball is executed, the virtual trackball may be executed and operated in the Enlarged Mode.

With respect to ending the operation of the virtual trackball, while the virtual trackball is being executed, the operation of the virtual trackball may be directly ended (or terminated) by selecting an End button, which is displayed on the touchscreen 20. Alternatively, the operation of the virtual trackball may be also automatically ended in accordance with separate settings pre-decided by the system developer (or designer).

According to an exemplary embodiment, the separate settings pre-decided by the system developer may correspond to a method of having the user end the execution of the virtual trackball by releasing contact of a touch contact point from the touchscreen 20 after using the virtual trackball, and a series of similar operations.

In addition to a local environment of a mobile user equipment, the method for controlling a touchscreen using a virtual trackball according to the present invention may also be applied to all functions requiring text input in a communication environment performing communication with an external target. Recently, when performing internet banking, a mouse input device, which is configured to input bank account numbers or passwords by using a mouse instead of a keyboard or keypad, is being applied in order to reinforce security. The mouse input device corresponds to a program, which is designed to execute a virtual keyboard in order to perform a safer wire-transaction, to convert the numbers being inputted through the virtual keyboard to encrypted text, and, then, to transmit the encrypted text. Herein, the virtual trackball and the cursor according to the present invention may be applied to the virtual keyboard, which is being executed by the above-described mouse input device. For example, when the mouse input device is being executed in an environment requiring text input, the virtual keyboard and the virtual trackball may be displayed in the input window of the touchscreen.

As described above, the method for controlling a touchscreen using a virtual trackball according to the present invention has the following advantages. By providing an enlarged display mode, users having poor eyesight can be capable of accurately and easily performing space shift and line change operations, which were initially difficult to perform due to the small display sizes of the text and cursor being displayed on the display screen of the output window, by using the virtual trackball. Moreover, by allowing the user to arbitrarily change the display size of the cursor being displayed on the output window of the enlarged display mode, the predetermined region surrounding the cursor, and the virtual trackball, user convenience may be enhanced.

The above-described device according to the exemplary embodiment of the present invention may be realized in the form of a hardware component, a software component, and/or a combination of a hardware component and a software component. For example, the device and corresponding components according to the above-described exemplary embodiments of the present invention may be realized by using at least one or more universal computers or special-purpose computers, such as a processor, a controller, an arithmetic logic unit (ALU), a digital signal processor, a field programmable array (FPA), a programmable logic unit (PLU), a microprocessor, or any type of device that can execute and respond to an instruction (or command). A processing device may execute an operating system (OS) and at least one or more software application, which is executed within the operating system (OS). Additionally, the processing device may respond to the execution of a software application, so as to access, store, manipulate, process, and generate data. In order to facilitate and simplify the understanding of the present invention, the present invention may be described to include only one processing device. However, it will be apparent to anyone skilled in the art that the processing device may include a plurality of processing elements and/or may include multiple types of processing elements. For example, the processing device may include multiple processors, or the processing device may include one processor and one controller. Additionally, other processing configuration, such as a parallel processor, may be configured herein.

The software may include a computer program, a code, an instruction, or a combination of one or more of the above. And, the software may configure a processing device, so that the processing device can be operated as intended, or the software may independently or collectively instruct (or command) the processing device. In order to be interpreted by the processing device, or in order to provide an instruction or data to the processing device, the software and/or data may be permanently or temporarily embodied in any type of machine, a component, a physical equipment (or device), a virtual equipment, a computer storage medium or device, or a transmitted signal wave. Since the software is dispersed (or scattered) within a computer system being connected to a network, the software may be stored or executed by using in a dispersion method. The software and data may be stored in one or more computer-readable recording media.

The method according to the exemplary embodiment of the present invention may be realized in a program command (or instruction) format that may be executed by using diverse computing means, so as to be recorded in a computer-readable medium. Herein, the computer-readable medium may independently include a program command (or instruction), a data file, a data structure, and so on, or may include a combination of the same. The program command being recorded in the medium may correspond to a program command that is specifically designed and configured for the exemplary embodiments of the present invention, or the program command may correspond to a program command that is disclosed and available to anyone skilled in or related to computer software. Examples of the computer-readable recording medium may include magnetic media, such as hard discs, floppy discs, and magnetic tapes, optical media, such as CD-ROMs, DVDs, and so on, magneto-optical media, such as floptical discs, and hardware devices specially configured (or designed) for storing and executing program commands, such as ROMs, RAMs, flash memories, and so on. Examples of a program command may not only include machine language codes, which are created by a compiler, but may also include high-level language codes, which may be executed by a computer by using an interpreter, and so on. The above-mentioned hardware equipment may be configured to be operated as one or more software modules for executing the operations of the exemplary embodiment of the present invention, and vice versa.

It will be apparent to those skilled in the art that various modifications and variations can be made in the present invention without departing from the spirit or scope of the inventions. For example, the above-described techniques may be executed in an order different from that described in the description of the present invention, and/or the components of the above-described system, structure, equipment (or device), circuit, and so on, may be combined in a format different that of the above-described method according to the present invention, and an adequate result may be achieved even if the above-described components of the present invention are replaced by any other component or its equivalent.

Thus, it is intended that the present invention covers other realizations and other embodiments of this invention provided they come within the scope of the appended claims and their equivalents.

What is claimed is:

1. As a method for controlling a touchscreen displaying text and a cursor on an output window, after differentiating an input window from an output window within the touchscreen, the method for controlling the touchscreen comprises:
displaying a virtual keyboard on the input window;
displaying a virtual trackball by selecting an Execute button on the virtual keyboard;
enlarging a cursor displayed on the output window and a predetermined region surrounding the cursor; and
inputting movement information of the cursor being enlarged and displayed by using the virtual trackball.

2. The method of claim 1, wherein the enlarging a cursor displayed on the output window and a predetermined region surrounding the cursor further comprises:
enlarging and displaying a virtual trackball of the input window.

3. The method of claim 2, wherein a user is capable of arbitrarily setting up a size of the virtual trackball being enlarged and displayed or sizes of the cursor and the surrounding region of the cursor both being enlarged and displayed.

4. The method of claim 1, further comprising:
having the user select an Enlarged Mode configured to enlarge and display a predetermined region of the output window.

5. The method of claim 4, wherein, in the enlarging a cursor displayed on the output window and a predetermined region surrounding the cursor, the Enlarged Mode is executed, in case the Execute button displayed on the virtual keyboard is selected for more than a predetermined period of time, or in case the Execute button is selected for more than a predetermined number of times, or in case a separate Select button is selected, when the Execute button has been selected.

6. The method of claim 1, wherein the virtual trackball is displayed on the input window in a region surrounding the Execute button.

7. The method of claim 1, wherein the movement information comprises movement direction information indicating a direction along which the cursor is being moved, and button information of the virtual trackball being used, when the cursor is moved.

8. The method of claim 7, wherein the movement direction information includes up, down, left, and right directions.

9. The method of claim 1, further comprising:
displaying the virtual trackball on the virtual keyboard, in case the virtual keyboard is being executed by a mouse input device, the mouse input device corresponding to a security program.
